(19) United States
(12) Patent Application Publication
(10) Pub. No.: US 2006/0265949 A1
(43) Pub. Date: Nov. 30, 2006

(54) Portable greenhouse

(76) Inventor: David L. Hiddema, Golden, CO (US)

Correspondence Address: DORR, CARSON & BIRNEY, P.C.;ONE CHERRY CENTER, 501 SOUTH CHERRY STREET, SUITE 800, DENVER, CO, 80246, US

(21) Appl. No.: 11/141,237

(22) Filed: May 31, 2005

(51) Int. Cl. A01G 9/16

(52) U.S. Cl. 47/17

(57) ABSTRACT

A portable greenhouse having a generally rectangular bottom and four side walls. An arched roof having a plurality of parallel translucent panels extends from a first side wall and has a distal edge that can be secured to an opposing second side wall to define an enclosed region within the side walls and beneath the roof. The opposing third and fourth side walls have curved upper portions beneath the roof with a number of windows to ventilate the greenhouse.

### BACKGROUND OF THE INVENTION

1. Field of the Invention

The present invention relates generally to the field of portable greenhouses and planters. More specifically, the present invention discloses a portable greenhouse having an arched translucent roof and ventilation windows.

2. Background of the Invention

A wide variety of portable greenhouses and planters for carrying plants have been used in the past. These products are used both for transporting plants to the garden, and also for protecting plants and seedlings from frost, rain and hail damage during the early growing season. This allows an earlier start and effectively extending the growing season.

The prior art in the general field includes the following:

| Inventor | Pat. No. | Issue Date |
|---|---|---|
| Chambers | 2,260,436 | Oct. 28, 1941 |
| Marsh | 4,068,423 | Jan. 17, 1978 |
| Westray | UK App. 2037555 | Jul. 16, 1980 |
| Pointon | 4,222,196 | Sep. 16, 1980 |
| Knablein et al. | 4,291,494 | Sep. 29, 1981 |
| Beder | 4,304,068 | Dec. 8, 1981 |
| Gutierrez | France 2580898 | Oct. 31, 1986 |
| Jantzen | 4,671,011 | Jun. 9, 1987 |
| Goodwin | UK App. 2191075 | Dec. 9, 1987 |
| Williamson | 4,792,082 | Dec. 20, 1988 |
| Caldwell | 4,809,592 | Mar. 7, 1989 |
| Heath | 4,940,016 | Jul. 10, 1990 |
| Allen | 5,056,259 | Oct. 15, 1991 |
| Naganobu | Japan 4258227 | Sep. 14, 1992 |
| Monetti et al. | 5,465,686 | Nov. 14, 1995 |
| Weder | Pub. 2003/0126791 | Jul. 10, 2003 |
| Weder | Pub. 2004/0065006 | Apr. 8, 2004 |
| Hilel et al. | Pub. 2004/0118038 | Jun. 24, 2004 |

None of the prior art references listed above show a portable greenhouse having the specific structure of the present invention. In particular, the present greenhouse includes an arched translucent roof and windows for ventilation. The present invention provides a portable greenhouse that is easy to manufacture and assemble, conveniently transports plants, and serves to shelter plants from frost, rain or hail damage.

### SUMMARY OF THE INVENTION

This invention provides a portable greenhouse having a generally rectangular bottom and four side walls. An arched roof having a plurality of parallel translucent panels extends from a first side wall and has a distal edge that can be secured to an opposing second side wall to define an enclosed region within the side walls and beneath the roof. The opposing third and fourth side walls have curved upper portions beneath the roof with a number of windows to ventilate the greenhouse.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a front perspective view of the assembled greenhouse.

FIG. 2 is another front perspective view of the assembled greenhouse showing more of its interior.

FIG. 3 is a top view of the sheet used to fabricate the greenhouse.

FIGS. 4, 5 and 6 are detail perspective views showing assembly of the roof brace 40.

FIGS. 7, 8 and 9 are detail perspective views showing assembly of the shutters.

FIG. 10 is a perspective view following completion of the step in FIG. 9, showing the side walls 31 and 32 being folded upward from the bottom 10.

FIGS. 11 and 12 are perspective views showing the tabs 42 of the roof brace being secured through slots in the side wall 32, and the door assemblies 21, 22 being folded closed.

FIG. 13 is a perspective view following completion of the steps in FIGS. 11 and 12, but prior to folding the roof panels 50 into place.

FIGS. 14 and 15 are perspective views showing the roof panels 50 being folded into place, with the roof tabs 51 being initially inserted into the slots 35 in the side wall 31.

FIG. 16a is a perspective view following completion of the steps in FIGS. 14 and 15, showing final insertion of the roof tabs 51 through two slots 35 in the side wall 31.

FIG. 16b is a detail perspective view corresponding to FIG. 16a showing insertion of a roof tab 51 through two slots 35 in the side wall 31.

### DETAILED DESCRIPTION OF THE INVENTION

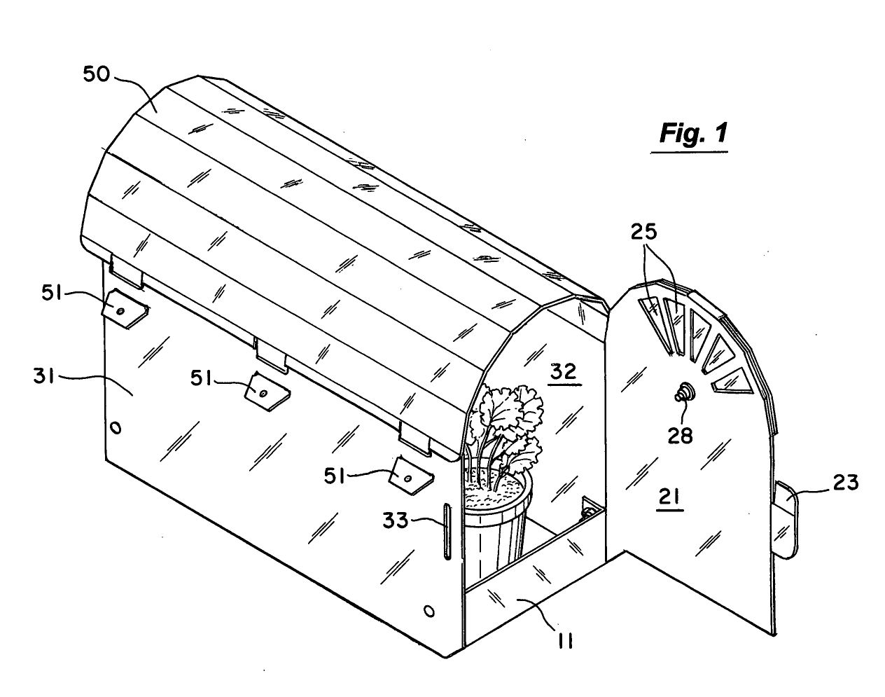

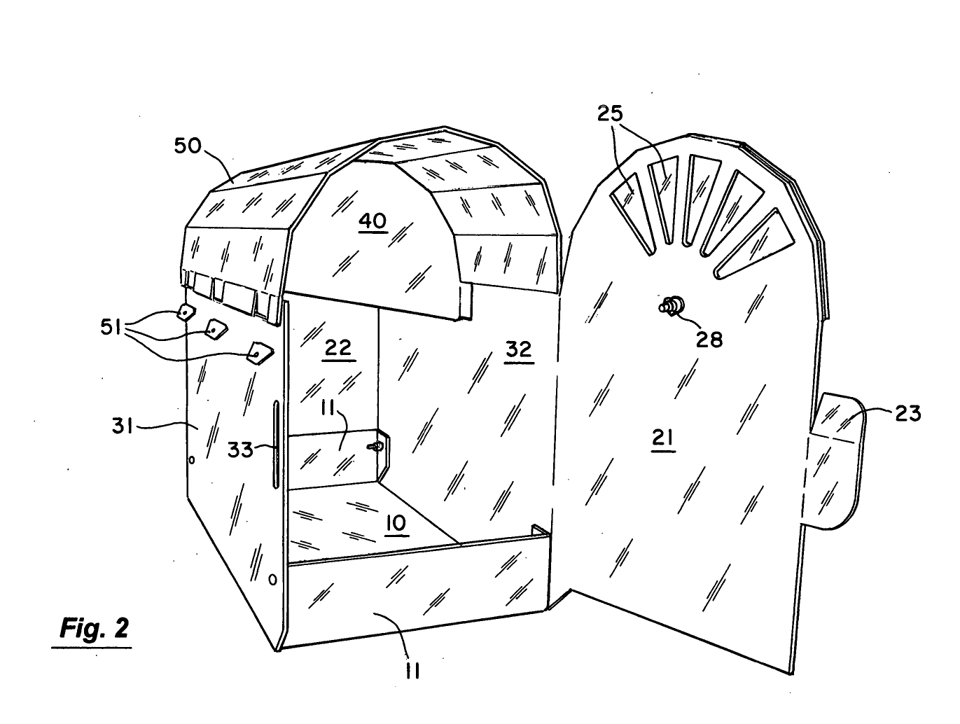

Turning to FIG. 1, a front perspective view is provided of the assembled greenhouse. FIG. 2 is another front perspective view of the assembled greenhouse showing more of its interior. The major components of the greenhouse include a generally rectangular bottom 10, four side walls 21, 22, 31 and 32 extending upward from the bottom 10, and an arched roof 50. These define an enclosed region within the side walls 21, 22, 31 and 32, beneath the roof 50 and above the bottom 10 suitable for housing plants.

In the preferred embodiment, the roof 50 has a plurality of parallel translucent panels separated by fold lines extending between opposing side walls 21, 22. The translucent panels curve to form the roof arch. One edge of the roof 50 extends from the upper portion of one of the side walls 32. The distal edge of the roof 50 can be secured to the opposing side wall 31 (e.g., by means of interlocking tabs 51 and slots 35 as shown in FIGS. 1 and 2).

The remaining set of opposing side walls 21 and 22 have curved upper portions beneath the roof 50. Windows 25 in the curved upper portions of these side walls 21, 22 allow ventilation of the interior of the greenhouse. Preferably, these window assemblies include shutters 27 to adjustably control air flow through the greenhouse and allow the windows to be closed, if desired.

In the embodiment of the invention shown in the drawings, the side walls 21, 22 are hinged to the edges of their adjacent side walls 31, 32 to serve as doors. This configuration provides ready access to the interior of the greenhouse via either door 21, 22. However, it should be expressly understood that other configurations could be substituted. For example, all four side walls could be fixed and the roof could be opened for access to the interior of the greenhouse. The number of doors and their size and placement are largely matters of design choice.

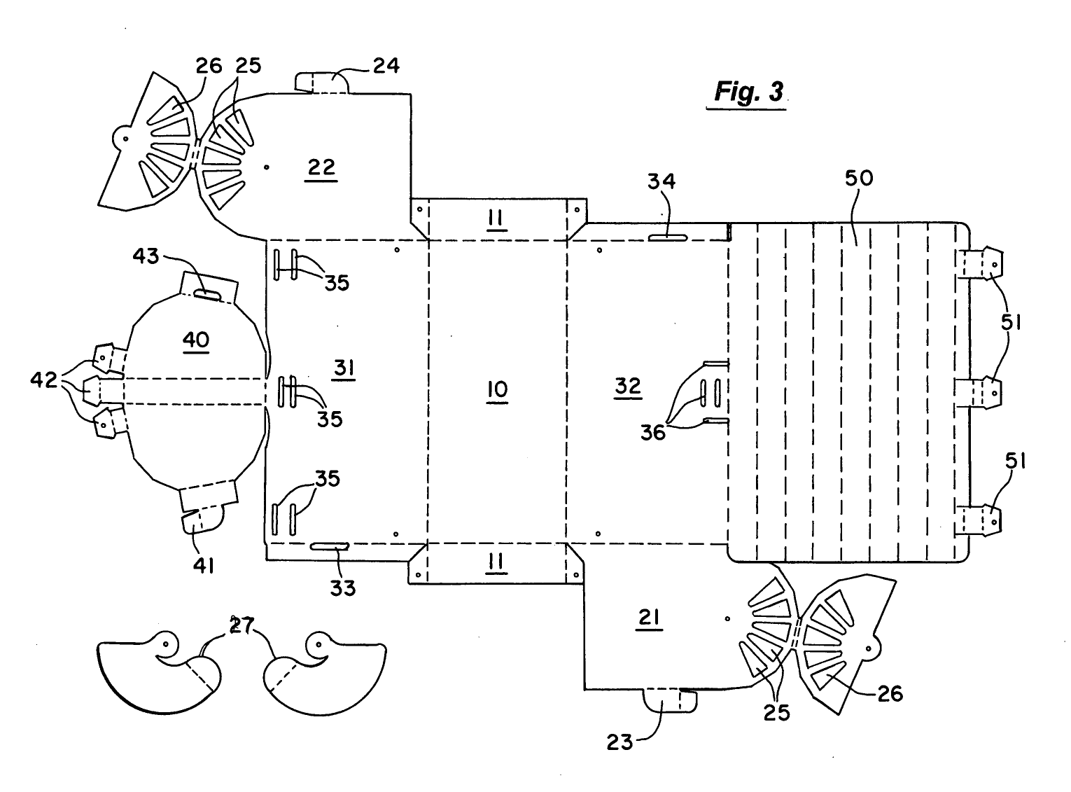

The remaining figures illustrate the steps in assembling the greenhouse. FIG. 3 is a top view of the sheet used to fabricate the greenhouse. For example, a double-walled, translucent, corrugated sheet of plastic is suitable for this purpose (e.g., poly panels or Corroplast panels). The double-walled construction enhances the thermal resistance of the structure which helps to retain heat and protect the plants from cold weather. The translucent nature of the material allows diffuse light to enter the greenhouse. This promotes photosynthesis by the plants and warms the interior of the greenhouse. The word “translucent” should be understood to include transparent materials, as well as materials that are only partially transmissive. Plastic also offers the advantage of being water-resistant, so that the greenhouse is largely impervious to possible damage from rain or water draining from the plants. In addition, plastic sheets can be easily die cut/stamped to create blanks with scored fold-lines for assembly, as shown in FIG. 3.

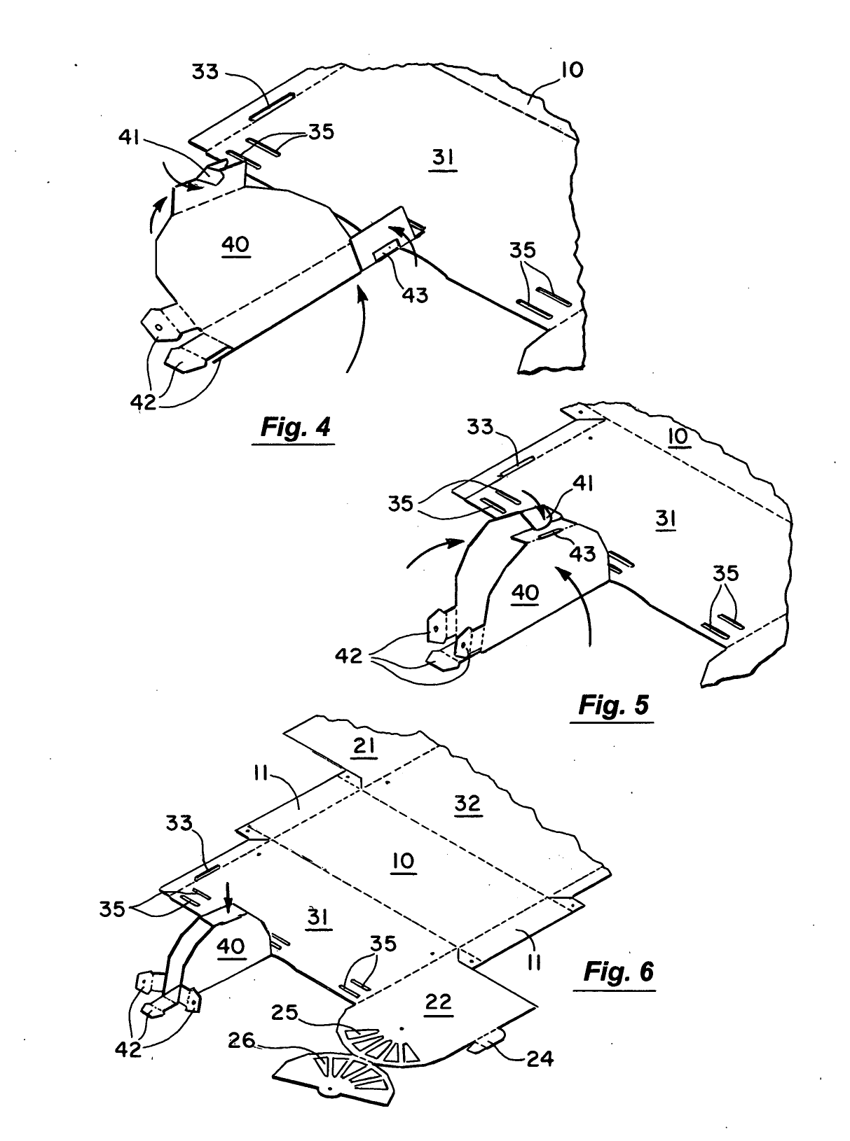

FIGS. 4-6 are detail perspective views showing assembly of the roof brace 40. The side flaps of the roof brace 40 are folded upward and the wing tabs are folded inward so that the latch flap 41 can be inserted into the slot 43, as shown in FIG. 5. Once inserted, the latch flap 41 is opened up to lock it in place in the slot 43 and complete assembly of the roof brace 40, as shown in FIG. 6.

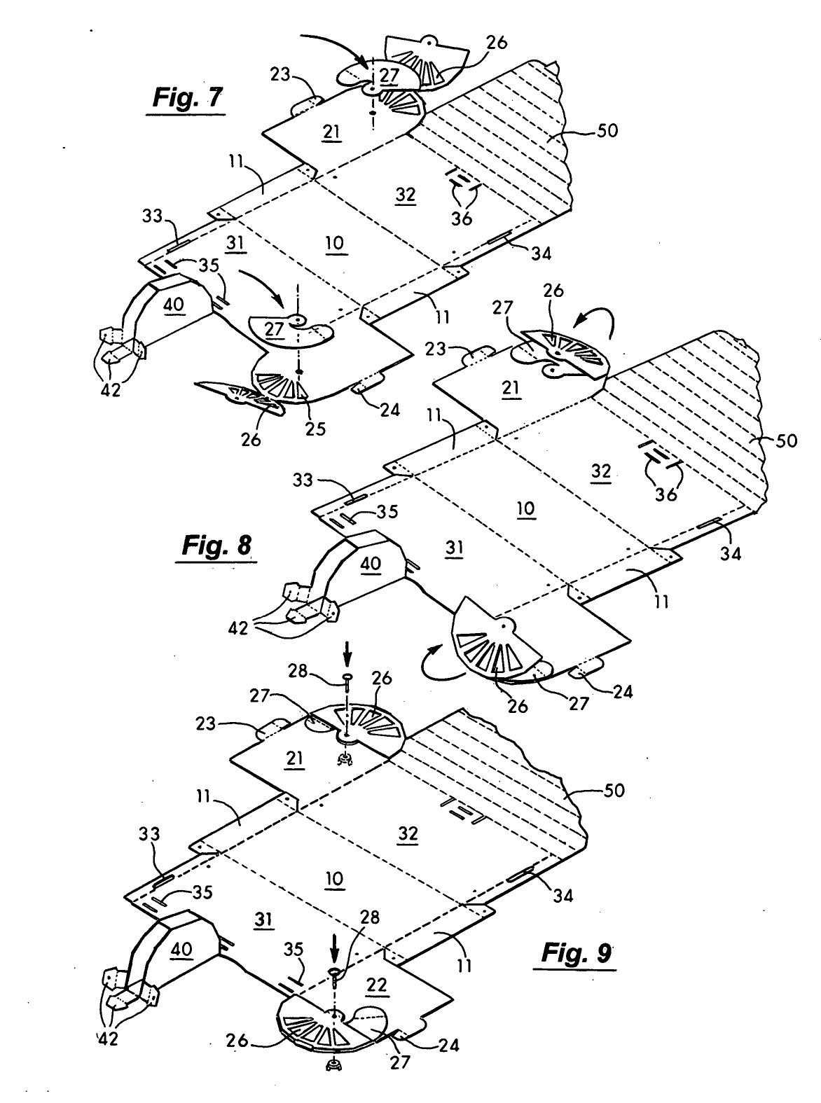

FIGS. 7-9 are detail perspective views showing assembly of the shutters. In the embodiment shown in the drawings, the windows of both doors 21, 22 are equipped with rotatable shutter mechanisms. As illustrated in FIGS. 7 and 8, the outer window frame 26 is folded over the inner window openings 25, with the shutter insert 27 sandwiched in between. The openings in the outer window frame 26 align with the window openings 25 in the doors 21, 22. A pin, clip or bolt 28 is then inserted through the outer window frame 26, shutter insert 27 and door 21 or 22 to act as a pivot point for rotation of the shutter insert 27 with respect to the window openings, as shown in FIG. 9. The round tab flap on the shutter insert 27 protrudes beyond the lower edge of the outer window frame 26 and provides a convenient handle for manual adjustment of the shutter position.

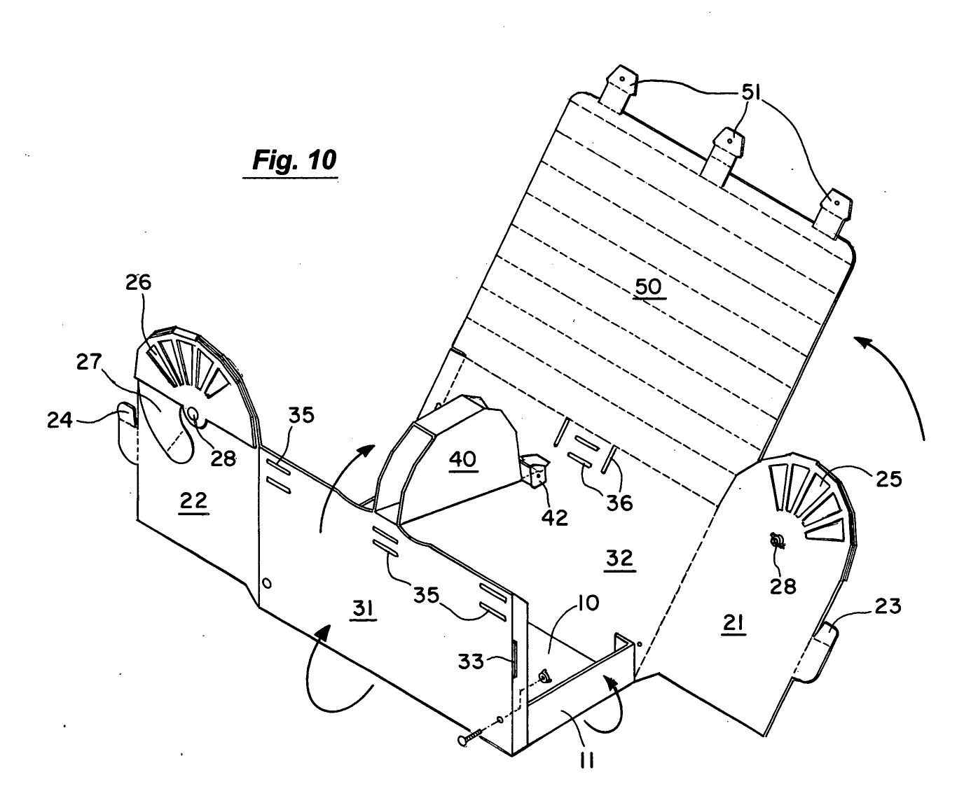

FIG. 10 is a perspective view showing the side walls 31, 32 and end braces 11 being folded upward from the bottom 10. The side walls 31, 32 are then secured to the end braces 11 (e.g., by means of fasteners, interlocking tabs and slots, or adhesives) to hold them in an upright position.

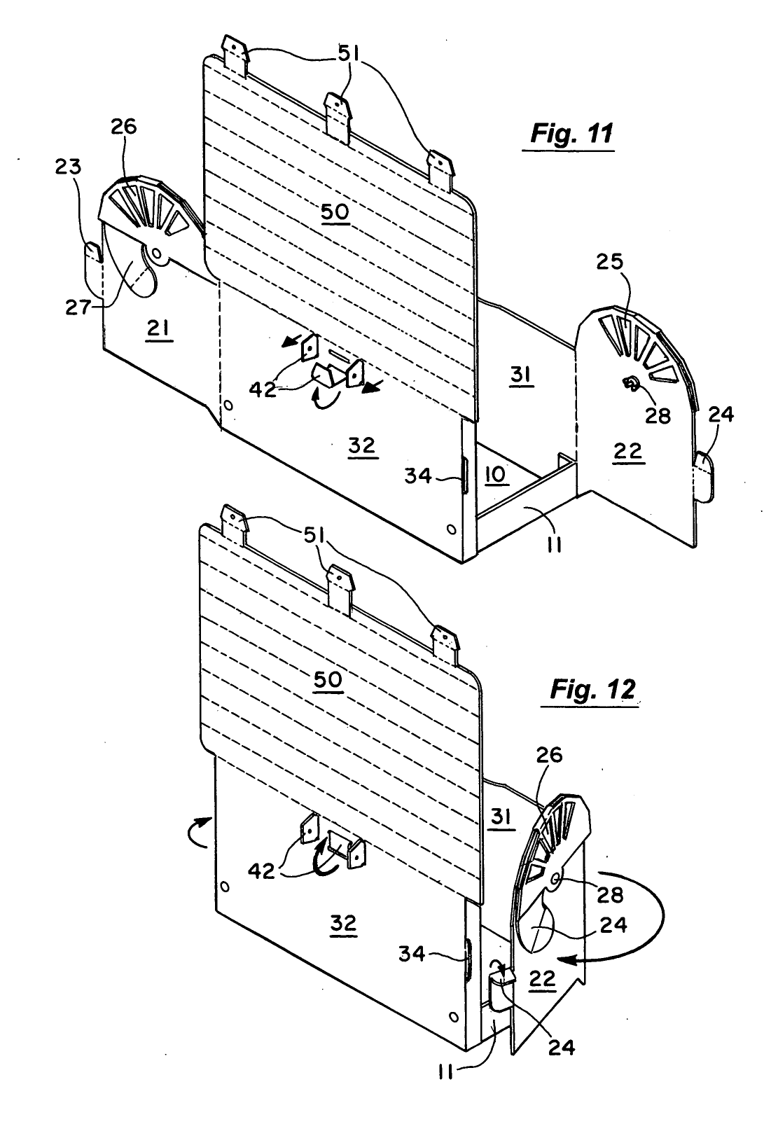

FIG. 11 is a perspective view showing the tabs 42 of the roof brace 40 being secured through slots 36 in the side wall 32. This anchors the roof brace 40 to both opposing side walls 31 and 32 to enhance structural rigidity.

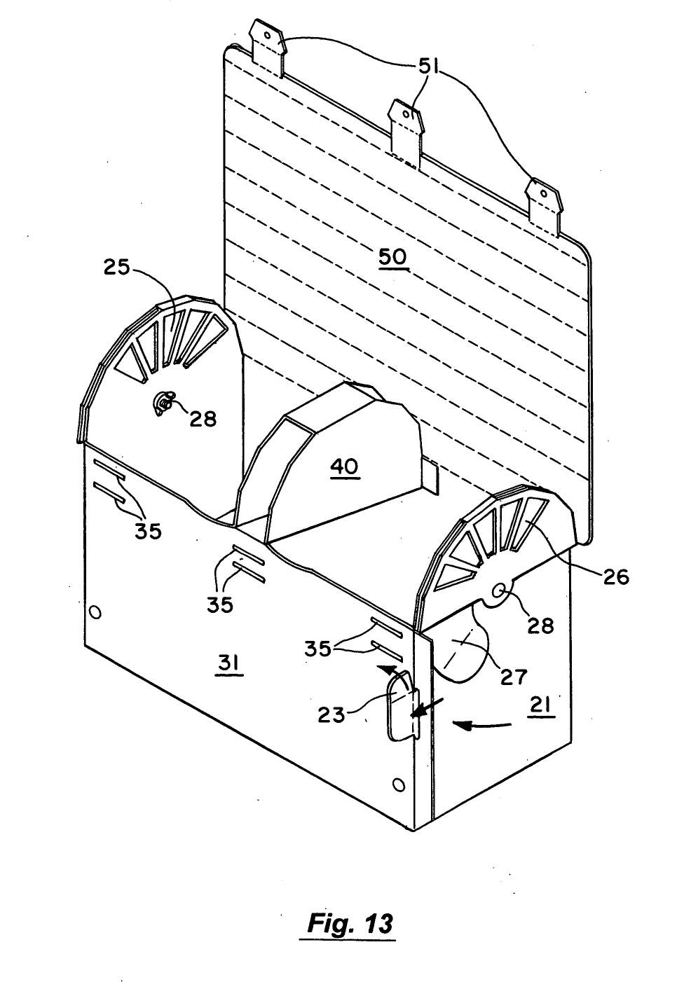

FIG. 12 is a perspective view showing the doors 21, 22 being folded closed. Wing tab latch flaps 23, 24 on the doors 21, 22 can be inserted into corresponding slots 33, 34 in the side walls 31, 32 to hold the doors 21, 22 closed as depicted in FIG. 13.

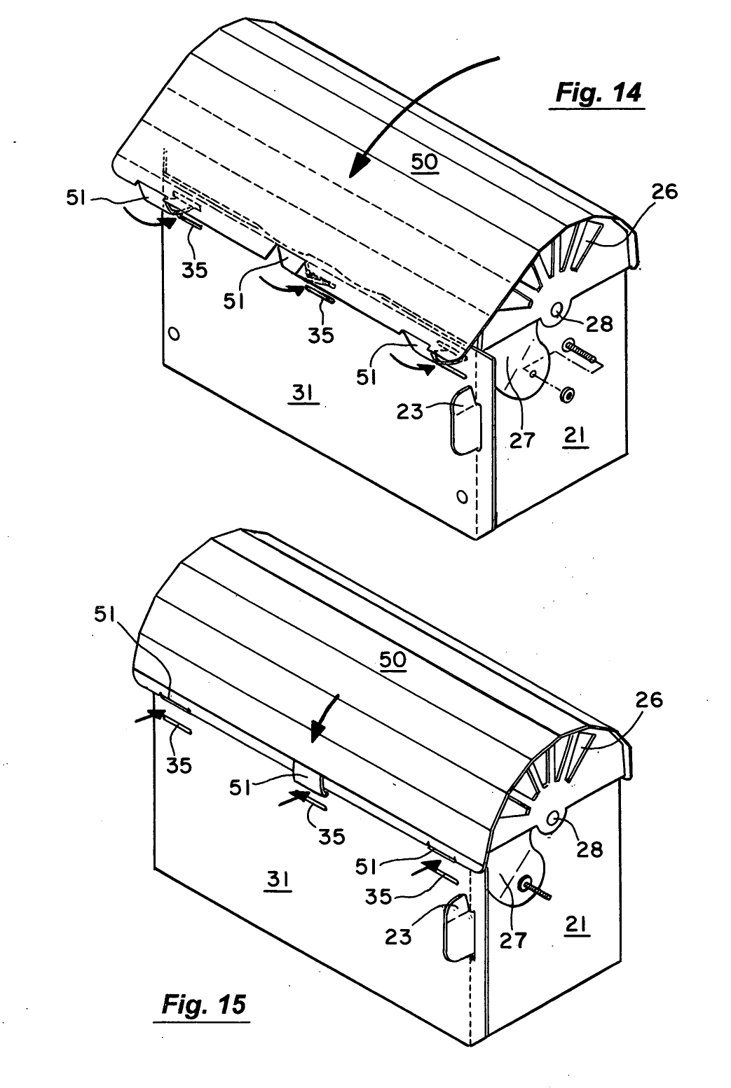

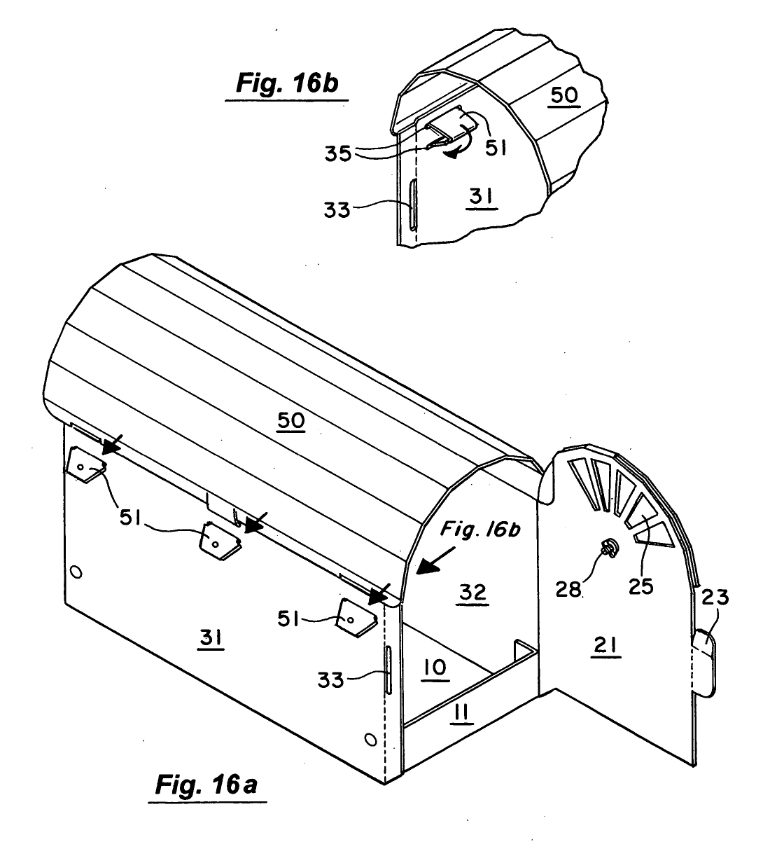

FIGS. 14 and 15 are perspective views showing the roof panels 50 folded into place and the roof tabs 51 inserted into the upper set of slots 35 in the side wall 31. FIG. 16a is a perspective view showing final insertion of the roof tabs 51 through both sets of slots 35. FIG. 16b is a detail perspective view corresponding to FIG. 16a showing insertion of a roof tab 51 through two slots 35 in the side wall 31.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

I claim:

1. A portable greenhouse comprising:
a generally rectangular bottom;
four side walls extending upward from the bottom;
an arched roof having a plurality of parallel translucent panels extending from a first side wall with a distal edge securable to an opposing second side wall to define an enclosed region within the side walls and beneath the roof, and wherein the opposing third and fourth side walls have curved upper portions beneath the roof; and
at least one window in the curved upper portions of the third and fourth side walls ventilating the enclosed region of the greenhouse.

2. The greenhouse of claim 1 wherein at least one of the side walls further comprises a door to access the enclosed region of the greenhouse.

3. The greenhouse of claim 1 wherein the parallel translucent panels of the roof are separated by fold lines allowing curvature of the roof into an arched shape.

4. The greenhouse of claim 1 wherein the translucent panels of the roof have a double-walled construction.

5. The greenhouse of claim 1 wherein the side walls are made of a translucent material.

6. The greenhouse of claim 1 wherein the side walls have a double-walled construction.

7. The greenhouse of claim 1 further comprising a shutter to selectively close the window.

8. The greenhouse of claim 1 further comprising a roof brace extended between two opposing side walls beneath the roof.

9. A portable greenhouse comprising:
a generally rectangular bottom;
two opposing side walls extending upward from the bottom;
two doors hingedly attached to the opposing side walls;
an arched roof having a plurality of parallel translucent panels extending from a first side wall with a distal edge securable to the opposing side wall to define an enclosed region within the side walls and doors and beneath the roof, and wherein the doors have curved upper portions beneath the roof; and
at least one window in the curved upper portion of a door ventilating the enclosed region of the greenhouse.

10. The greenhouse of claim 9 wherein the translucent panels of the roof have a double-walled construction.

11. The greenhouse of claim 9 wherein the side walls are made of a translucent material.

12. The greenhouse of claim 9 wherein the side walls have a double-walled construction.

13. The greenhouse of claim 9 further comprising a shutter to selectively close the window.

14. The greenhouse of claim 13 wherein the shutter rotates to adjustably control the degree to which the window is closed.

15. The greenhouse of claim 9 further comprising a roof brace extended between two opposing side walls beneath the roof.

16. A portable greenhouse comprising:
a generally rectangular bottom;
four translucent side walls extending upward from the bottom;
an arched roof having a plurality of parallel translucent panels extending from a first side wall with a distal edge securable to an opposing second side wall to define an enclosed region within the side walls and beneath the roof, and wherein the opposing third and fourth side walls have curved upper portions beneath the roof;
at least one window in the curved upper portions of the third and fourth side walls ventilating the enclosed region of the greenhouse; and
at least one rotating shutter in the curved upper portions of the third and fourth side walls to adjustably control the degree to which the window is closed.

17. The greenhouse of claim 16 wherein at least one of the side walls further comprises a door to access the enclosed region of the greenhouse.

18. The greenhouse of claim 16 wherein the parallel translucent panels of the roof are separated by fold lines allowing curvature of the roof into an arched shape.

19. The greenhouse of claim 16 wherein the translucent panels of the roof have a double-walled construction.

20. The greenhouse of claim 16 wherein the side walls have a double-walled construction.
